(19) United States
(12) Patent Application Publication
(10) Pub. No.: US 2026/0336594 A1
(43) Pub. Date: Oct. 29, 2026

(54) BRAKE SYSTEM AND CONTROL METHOD THEREOF

(71) Applicant: HL MANDO CORPORATION, Pyeongtaek-si (KR)

(72) Inventor: Dongil SEO, Pyeongtaek-si (KR)

(73) Assignee: HL MANDO CORPORATION, Pyeongtaek-si (KR)

(21) Appl. No.: 19/372,952

(22) Filed: Oct. 29, 2025

(30) Foreign Application Priority Data
Apr. 28, 2025 (KR) 10-2025-0055816

(51) Int. Cl. B60T 17/22; B60T 13/74

(52) U.S. Cl. CPC B60T 17/221; B60T 13/746

(57) ABSTRACT

A brake system comprises an electro-mechanical brake including a motor and a ratchet unit and configured to brake a wheel of a vehicle based on driving the motor and to engage a parking brake through operating the ratchet unit; a memory configured to store state information of the parking brake of the electro-mechanical brake; and an electro-mechanical brake controller configured to control the motor and the ratchet unit, wherein the electro-mechanical brake controller is configured to identify whether the parking brake of the electro-mechanical brake is in an engaged state or a disengaged state based on the state information stored in the memory, in response to the vehicle’s ignition on.

### CROSS-REFERENCE TO RELATED APPLICATIONS

This application claims the benefit of Korean Patent Application No. 2025-0055816, filed on Apr. 28, 2025 in the Korean Intellectual Property Office, the disclosure of which is incorporated herein by reference.

### BACKGROUND

### Technical Field

The present disclosure relates to a brake system and controlling method thereof.

### Description of the Related Art

A brake system for performing braking is essentially installed in a vehicle, and recently, Electro-Mechanical Brakes (EMB), which generate braking force by operating electric actuators such as motors based on electrical signals that convey the driver's braking intention, have been developed.

The electro-mechanical brake is a device that generates braking force using an electric actuator instead of hydraulic pressure, offering superior braking response and control performance compared to hydraulic brakes. In addition, the electro-mechanical brake allows for more efficient design and weight reduction, as well as easier maintenance compared to a hydraulic brake system.

Meanwhile, the electro-mechanical brake allows manual release of the park mechanism in a shut-down state through a manual release notch mechanism.

The manual release mechanism, typically comprising a one-way lever or cable system, is designed only to pull the pawl away from the ratchet, and lacks a mechanism to actively push it into an engaged position. Therefore, manual operation can only transition the parking brake from an engaged to a disengaged state, but not vice-versa.

Accordingly, since the engagement status of the park mechanism recorded in memory before the shut-down of the electro-mechanical brake cannot be reliably trusted in the next wake-up cycle, a separate physical inspection of the park mechanism’s status has been performed during every initialization state to determine the engagement status of the park mechanism.

### BRIEF SUMMARY

One aspect of the present disclosure is to provide a brake system and a control method thereof, which can maintain the reliability of the initial state check of an electro-mechanical parking brake, and reduce the time required for the initial state check based on the state of a previous ignition operation cycle (also referred to as a power cycle) of the brake system.

According to one aspect of the present disclosure, there is provided a brake system comprising: an electro-mechanical brake including a motor and a ratchet unit and configured to brake a wheel of a vehicle based on driving the motor and to engage a parking brake through operating the ratchet unit; a memory configured to store state information of the parking brake of the electro-mechanical brake; and a processor configured to control the motor and the ratchet unit, wherein the electro-mechanical brake controller is configured to identify whether the parking brake of the electro-mechanical brake is in an engaged state or a disengaged state based on the state information stored in the memory, in response to the vehicle’s ignition on.

The state information may be state information of the parking brake stored immediately before the brake system is deactivated in response to the vehicle’s ignition off.

The processor may identify that the parking brake is in the disengaged state when the state information stored in the memory is in the disengaged state.

The processor may perform a physical state check to identify whether the parking brake is in the engaged state or the disengaged state when the state information stored in the memory is in the engaged state.

The processor may identify whether the parking brake is in the engaged state or the disengaged state based on the physical state check.

The processor may perform the physical state check based on driving control of the motor.

The electro-mechanical brake may further include a drive pulley configured to rotate based on a driving force of the motor, and the processor may identify that the parking brake is in the disengaged state when the drive pulley rotates in response to the driving control of the motor.

The ratchet unit may include a solenoid driver configured to generate mechanical motion based on a control signal from the electro-mechanical brake controller, and a pawl configured to be moved by driving of the solenoid driver and be seated in a groove of a sawtooth protrusion on the drive pulley.

The solenoid driver may include a solenoid coil configured to generate a magnetic field based on an electrical signal from the electro-mechanical brake controller, an armature configured to move by the magnetic field generated by the solenoid coil, and a pin configured to push the pawl in accordance with movement of the armature.

The processor may update the state information stored in the memory to current state information of the parking brake in response to identification of the vehicle’s ignition off signal.

According to one aspect of the present disclosure, there is provided a control method of a brake system comprising an electro-mechanical brake including a motor and a ratchet unit and configured to brake a wheel of a vehicle based on driving the motor and to engage a parking brake through operating the ratchet unit, the control method comprising: identifying pre-stored state information of the electro-mechanical brake in response to the vehicle’s ignition on; and identifying whether the parking brake of the electro-mechanical brake is in an engaged state or a disengaged state based on the pre-stored state information.

The pre-stored state information may be state information of the parking brake stored immediately before the brake system is deactivated in response to the vehicle’s ignition off.

The identifying of whether the parking brake of the electro-mechanical brake is in the engaged state or the disengaged state may include identifying that the parking brake is in the disengaged state when the pre-stored state information is in the disengaged state.

The identifying of whether the parking brake of the electro-mechanical brake is in the engaged state or the disengaged state may include performing a physical state check to identify whether the parking brake is in the engaged state or the disengaged state when the pre-stored state information is in the engaged state.

The identifying of whether the parking brake of the electro-mechanical brake is in the engaged state or the disengaged state may be performed based on the physical state check of the parking brake.

The performing of the physical state check may be based on driving control of the motor.

The identifying of whether the parking brake of the electro-mechanical brake is in the engaged state or the disengaged state may include identifying that the parking brake is in the disengaged state when a drive pulley of the electro-mechanical brake rotates in response to driving control of the motor.

The ratchet unit may include a solenoid driver configured to generate mechanical motion, and a pawl configured to be moved by driving of the solenoid driver and be seated in a groove of a sawtooth protrusion on the drive pulley.

The solenoid driver may include a solenoid coil configured to generate a magnetic field based on a received electrical signal, an armature configured to move by the magnetic field generated by the solenoid coil, and a pin configured to push the pawl in accordance with movement of the armature.

The control method may further comprise updating the pre-stored state information to current state information of the parking brake in response to occurrence of the vehicle’s ignition off signal.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a diagram showing the configuration of a brake system according to an embodiment of the present disclosure.

FIG. 2 is a simplified cross-sectional view of a caliper brake according to an embodiment of the present disclosure.

FIG. 3 is a simplified perspective view of an actuator assembly of an electro-mechanical brake according to an embodiment of the present disclosure.

FIG. 4 is a cross-sectional view showing a ratchet unit and a first drive pulley of the actuator assembly according to an embodiment of the present disclosure.

FIG. 5 is a flowchart of the operation of the brake system according to an embodiment of the present disclosure.

FIG. 6 is a flowchart of the operation of an electro-mechanical brake controller of the brake system according to an embodiment of the present disclosure.

### DETAILED DESCRIPTION

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

Hereinafter, the operating principle and embodiments of the present disclosure will be described with reference to the attached drawings.

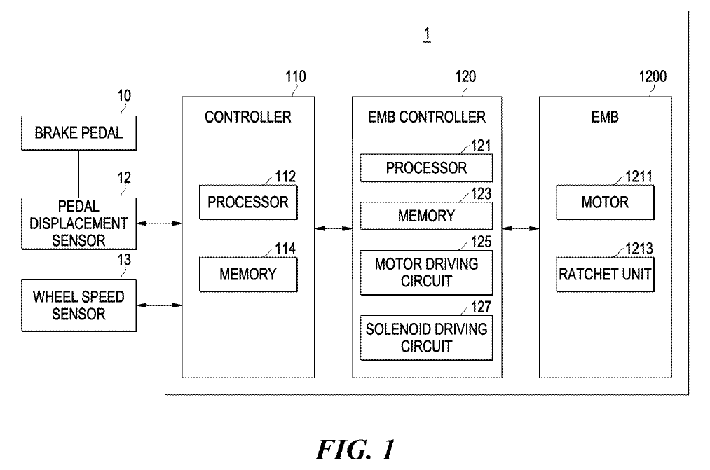

FIG. 1 is a diagram showing the configuration of a brake system according to an embodiment of the present disclosure.

Referring to FIG. 1, the brake system 1 may include a controller 110, an electro-mechanical brake controller 120, and an electro-mechanical brake 1200.

The controller 110 is electrically or communicatively connected to the electro-mechanical brake controller 120 and may provide a control signal to the electro-mechanical brake controller 120. For example, although omitted in FIG. 1, the controller 110 may include a communication circuit.

The controller 110 may be electrically or communicatively connected to a pedal displacement sensor 12 for a vehicle brake pedal 10 and/or a wheel speed sensor 13 provided on the vehicle’s wheels.

The controller 110 may receive signals output from the pedal displacement sensor 12 and/or the wheel speed sensor 13.

The pedal displacement sensor 12 may detect the displacement of the brake pedal 10 (or acquire displacement information).

For example, the pedal displacement sensor 12 may be physically connected to the brake pedal 10 to measure the movement of the brake pedal 10. The pedal displacement sensor 12 may detect a displacement distance and/or displacement speed from a reference position of the brake pedal 10.

The pedal displacement sensor 12 may transmit an electrical signal corresponding to the displacement distance and/or displacement speed of the brake pedal 10 to the controller 110.

The wheel speed sensor 13 may detect the speed of the corresponding wheel (also referred to as the rotational speed of the wheel).

The wheel speed sensor 13 may transmit an electrical signal corresponding to the rotational speed of the wheel to the controller 110.

The controller 110 may generate a target braking clamping force based on signals received from the pedal displacement sensor 12 and/or the wheel speed sensor 13.

The controller 110 may provide a control signal including a target braking clamping force to the electro-mechanical brake controller 120.

The controller 110 may provide a parking brake engagement control signal by the electro-mechanical brake 1200 to the electro-mechanical brake controller 120 in response to receiving a signal indicating vehicle stop identification or a parking switch (not shown).

For example, the controller 110 may identify the vehicle’s stopped state based on information acquired through signals output from a speed sensor that obtains the vehicle speed and/or the wheel speed sensor 13, and provide a parking brake engagement control signal to the electro-mechanical brake controller 120 based on the identification of the vehicle’s stopped state. In addition, the controller 110 may provide a parking brake engagement control signal to the electro-mechanical brake controller 120 based on receiving a signal output from a parking switch operated by the driver.

The controller 110 may provide a parking brake release control signal to the electro-mechanical brake controller 120 in response to receiving a signal output from a parking switch (not shown).

The controller 110 may be referred to as a brake control unit (BCU) and may include an electronic control unit (ECU).

The controller 110 may include a processor 112 and/or a memory 114.

The processor 112 may process output signals from the pedal displacement sensor 12 and/or the wheel speed sensor 13 to determine a target braking clamping force.

The processor 112 may generate a control signal including the target braking clamping force and transmit the control signal to the electro-mechanical brake controller 120.

The processor 112 may transmit parking brake engage and disengage signals (also referred to as apply and release signals) to the electro-mechanical brake controller 120.

The memory 114 may store or record programs and data for implementing operations to control components included in the brake system 100 by the processor 112.

The memory 114 may provide stored programs and data to the processor 112 and may store temporary data generated during operation of the processor 112.

For example, the memory 114 may include volatile memory such as static random access memory (S-RAM) and dynamic random access memory (D-RAM), and non-volatile memory such as read-only memory (ROM), erasable programmable read-only memory (EPROM), electrically erasable programmable read-only memory (EEPROM), and flash memory.

The electro-mechanical brake controller 120 may receive a target braking clamping force from the controller 110 and may control the electro-mechanical brake 1200 to apply braking to the corresponding wheel based on the received target force.

The electro-mechanical brake controller 120 may receive a parking brake engagement control signal or disengagement control signal from the controller 110 and may control the electro-mechanical brake 1200 to engage or disengage the parking brake based on the received signal.

The electro-mechanical brake controller 120 may store state information of the parking brake—indicating whether the parking brake of the electro-mechanical brake 1200 is in an engaged state or a disengaged state—into a memory 123 (e.g., EEPROM) of the electro-mechanical brake controller 120 before the brake system 1 is deactivated (also referred to as shut-down) in response to occurrence of a vehicle ignition-off signal.

After a wake-up following ignition-on of the vehicle, the electro-mechanical brake controller 120 may identify parking brake state information of the electro-mechanical brake 1200 that was pre-stored in the memory 123, i.e., stored in response to a previous ignition-off, in an initialization state.

When the pre-stored parking brake state information of the electro-mechanical brake 1200 in the memory 123 indicates an engaged state, the electro-mechanical brake controller 120 may perform a physical state check of the parking brake mechanism.

The electro-mechanical brake controller 120 may identify the state of the parking brake based on the result of the physical state check.

When the pre-stored parking brake state of the electro-mechanical brake 1200 in the memory 123 indicates a disengaged state, the electro-mechanical brake controller 120 may identify the parking brake state as the disengaged state without performing a physical state check of the parking brake mechanism.

The reason the electro-mechanical brake controller 120 directly identifies the parking brake state as the disengaged state when the pre-stored state information in the memory 123 indicates a disengaged state is based on the characteristic that, in the shutdown state of the brake system 1, the parking brake of the electro-mechanical brake 1200 can be manually disengaged if it is engaged, but it cannot be manually engaged if it is disengaged.

Since the electro-mechanical brake controller 120 does not perform a physical state check of the parking brake mechanism when the pre-stored state information of the parking brake of the electro-mechanical brake 1200 in the memory 123 indicates a disengaged state, it can provide the effect of reducing the time required for the initialization state.

The electro-mechanical brake controller 120 may include a processor 121, a memory 123, a motor driving circuit 125, and/or a solenoid driving circuit 127.

The processor 121 may generate a signal to control a motor 1211 of the electro-mechanical brake 1200 by converting a target braking clamping force of the electro-mechanical brake 1200 into torque of the motor 1211.

The processor 121 may generate a signal to control the motor 1211 for engagement and/or disengagement control of the parking brake of the electro-mechanical brake 1200, and/or a signal to control a ratchet unit 1213 of an actuator assembly 1210 (described below).

The memory 123 may store or record programs and data for implementing operations to control components included in the electro-mechanical brake 1200 by the processor 121.

For example, the memory 123 may include volatile memory such as static random access memory (S-RAM) and dynamic random access memory (D-RAM), and non-volatile memory such as read-only memory (ROM), erasable programmable read-only memory (EPROM), electrically erasable programmable read-only memory (EEPROM), and flash memory.

The motor driving circuit 125 may drive the motor 1211 of the electro-mechanical brake 1200 based on a control signal from the processor 121. For example, the motor driving circuit 125 may receive a signal from the processor 121 and adjust the current of the motor 1211. The speed and torque of the motor 1211 may be adjusted according to the adjustment of the motor current.

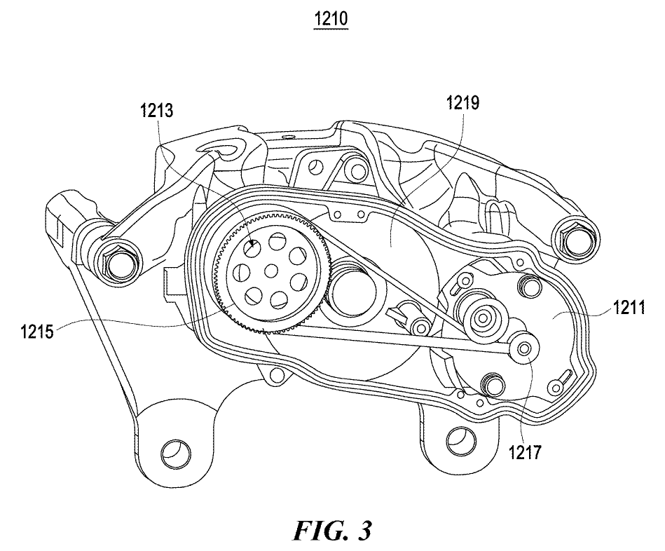

The solenoid driving circuit 127 may drive a solenoid driver (301 in FIG. 3) included in the ratchet unit 1213 of the electro-mechanical brake 1200 based on a control signal from the processor 121. For example, the solenoid driving circuit 127 may receive a signal from the processor 121 and provide an electrical signal such that a solenoid coil 3011 generates a magnetic field.

The electro-mechanical brake 1200 may implement braking force generation, parking brake engagement, and/or parking brake disengagement based on reception of control signals from the electro-mechanical brake controller 120.

The electro-mechanical brake 1200 may include a motor 1211 and a ratchet unit 1213.

The motor 1211 has a rotary shaft, and the electro-mechanical brake 1200 may generate braking force based on the rotational driving force of the motor 1211.

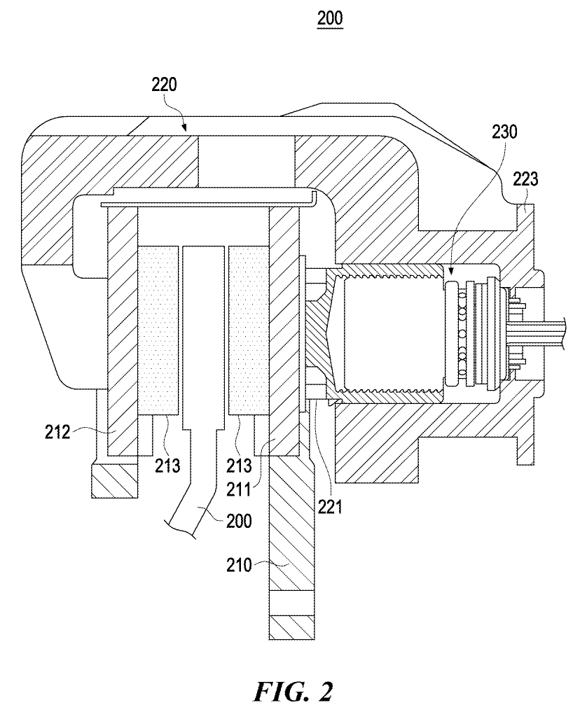

The electro-mechanical brake 1200 may include a caliper brake as shown in FIG. 2.

FIG. 2 is a simplified cross-sectional view of a caliper brake according to an embodiment of the present disclosure.

Referring to FIG. 2, the caliper brake 200 may include a brake disk 200 that rotates with the corresponding wheel, a pair of pad plates 211 and 212 that are provided to pressurize the brake disk 200, a brake pad 213 attached to one surface of each of the pair of pad plates 211 and 212 and, more specifically to one surface facing the brake disk 200, a carrier 210 provided with a pair of pad plates 211 and 212 to move forward and backward, a caliper housing 220 equipped with a cylinder 223 that is installed slidably in the carrier 210 and where the piston 221 is installed to move forward and backward by an actuating force from a power conversion unit 230, the power conversion unit 230 pressurizing the piston 221, a motor(e.g., motor 1211 shown in FIG. 1) with a rotary shaft and/or a motor actuator (not shown) that transmits rotational force to the power conversion unit 230 using the motor.

According to the above-described configuration, the rotational driving force of the motor(s) 1211 is transmitted to the pad plates 211 and 212 through the power conversion unit 230 and the transmitted rotational driving force moves the pad plates 211 and 212 forward and backward to press the brake disk 200, thereby enabling the corresponding electro-mechanical brake 1200 to generate braking force.

The ratchet unit 1213 prevents reverse rotation of the electro-mechanical brake 1200 according to the rotational driving force of the motor 1211, thereby ensuring stable braking force and enabling the implementation of a parking brake that engages the electro-mechanical brake 1200.

The motor 1211 and the ratchet unit 1213 may be implemented as a single actuator assembly, as shown in FIG. 3.

FIG. 3 is a simplified perspective view of an actuator assembly of an electro-mechanical brake 1200 according to an embodiment of the present disclosure.

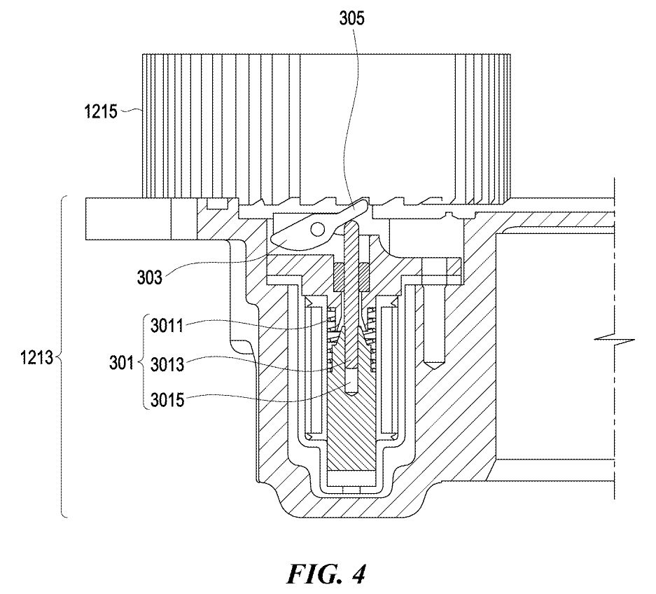

FIG. 4 is a cross-sectional view showing a ratchet unit and a first drive pulley of the actuator assembly according to an embodiment of the present disclosure.

Referring to FIG. 3, the actuator assembly 1210 of the electro-mechanical brake 1200 may include a motor 1211, a ratchet unit 1213, a first drive pulley 1215 (also referred to as a driven pulley), a second drive pulley 1217 (also referred to as a driving pulley), and a belt 1219.

The second drive pulley 1217 may be connected to the rotating shaft of the motor 1211, and the first drive pulley 1215 may be prevented from rotating by the ratchet unit 1213.

The first drive pulley 1215 and the second drive pulley 1217 may be rotatably connected to each other via the belt 1219.

According to the above-described configuration, the rotational driving force of the motor 1211 is transmitted to the first drive pulley 1215 through the second drive pulley 1217, allowing the parking brake to be engaged or disengaged.

Meanwhile, referring to FIG. 4, the ratchet unit 1213 may include a solenoid actuator 301, a pawl 303, and/or a torsion spring 305.

The solenoid actuator 301 can rotate the pawl 303 so that the pawl 303 engages or disengages with the sawtooth of the first drive pulley 1215.

The solenoid actuator 301 may include a solenoid coil 3011, an armature 3013, and/or a pin 3015.

The solenoid coil 3011 can generate a magnetic field in response to an electrical signal from the electro-mechanical brake controller 120.

The armature 3013 can move linearly forward and backward inside the solenoid coil 3011 due to the magnetic field generated by the solenoid coil 3011. The forward and backward movement of the armature 3013 can cause the pawl 303 to move so that it engages or disengages with the sawtooth of the first drive pulley 1215, which is disposed above the ratchet unit 1213.

The pin 3015 is press-fitted into the armature 3013 and can push the pawl 303 according to the movement of the armature 3013.

The pawl (303) is moved by the armature (3013) and may engage or disengage with the sawtooth of the first drive pulley (1215).

The pawl (303) can engage with the sawtooth of the first drive pulley (1215) to engage the parking brake, or move so as not to engage with the sawtooth to implement the disengagement of the parking brake.

The torsion spring (305) is provided on the pawl (303) and can provide an elastic force that pushes the pawl (303) away from the first drive pulley (1215).

The first drive pulley 1215 may receive driving power from the motor 1211 and rotate, and the rotational force of the first drive pulley 1215 may implement engagement or disengagement of the parking brake.

For example, the first drive pulley 1215 may include sawtooth-shaped protrusions, and when the pawl 303 is seated in the groove of the sawtooth-shaped protrusions, the parking brake may be engaged; otherwise, the parking brake may be disengaged.

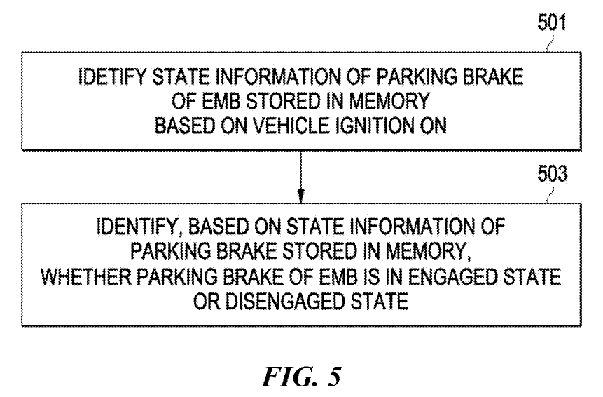

FIG. 5 is a flowchart of the operation of the brake system 1 (and/or the electro-mechanical brake controller 120) according to an embodiment of the present disclosure.

Referring to FIG. 5, the brake system 1 may identify the state information of the parking brake of the electro-mechanical brake 1200 stored in the memory 123 based on the vehicle ignition ON signal (501).

The state information of the parking brake stored in the memory 123 may be information identified and stored immediately before the brake system 1 is deactivated in response to the vehicle ignition OFF, just prior to the vehicle ignition ON.

The brake system 1 may identify, based on the state information of the parking brake stored in the memory 123, whether the parking brake of the electro-mechanical brake 1200 is in an engaged state or a disengaged state (503).

The brake system 1 may identify the parking brake of the electro-mechanical brake 1200 as being in the disengaged state when the state information of the electro-mechanical brake 1200 stored in the memory 123 is in the disengaged state.

The brake system 1 may perform a physical state check of the parking brake mechanism of the electro-mechanical brake 1200 when the state information of the electro-mechanical brake 1200 stored in the memory 123 is in the engaged state.

For example, the brake system 1 may identify the parking brake as being in the disengaged state when the first drive pulley 1215 rotates in response to the drive control of the motor 1211.

The brake system 1 may identify whether the parking brake is engaged or disengaged based on a signal output from the position sensor (not shown) of the motor 1211 in response to the drive control of the motor 1211. For example, motor position information corresponding to the engagement of the parking brake may be previously stored, and the brake system 1 may identify the engagement status of the parking brake based on a comparison between the previously stored motor position information corresponding to the parking brake engagement and the position information acquired based on the signal output from the position sensor.

Meanwhile, in addition to the above-described embodiment, the brake system 1 may transmit information indicating the identification result of whether the parking brake of the electro-mechanical brake 1200 is engaged or disengaged to a vehicle output device (e.g., a display and/or speaker), so that the vehicle output device outputs the information.

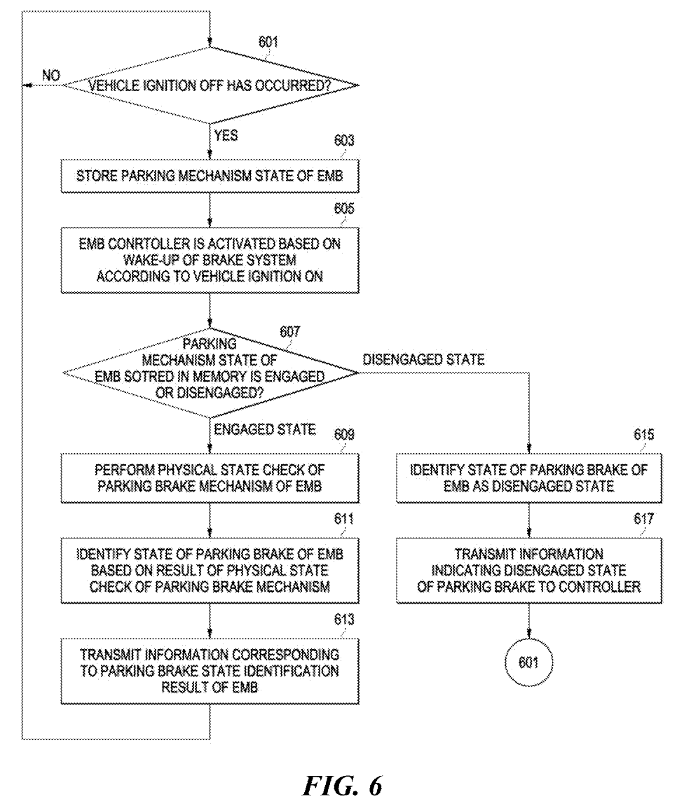

FIG. 6 is a flowchart of the operation of an electro-mechanical brake controller 120 of the brake system 1 according to an embodiment of the present disclosure.

Referring to FIG. 6, the electro-mechanical brake controller 120 may identify whether the vehicle ignition OFF has occurred (601).

The electro-mechanical brake controller 120 may identify that the vehicle ignition OFF has occurred based on receiving a signal indicating the occurrence of the vehicle ignition OFF from the controller 110.

The electro-mechanical brake controller 120 may perform operation 603 when the vehicle ignition OFF has occurred, and may perform operation 601 again if it has not.

The electro-mechanical brake controller 120 may store the parking mechanism state of the electro-mechanical brake 1200, that is, it may store whether the parking brake of the electro-mechanical brake 1200 is engaged or disengaged (603).

After a certain period of time has elapsed following the occurrence of the vehicle ignition OFF, the brake system 1 may be deactivated.

Accordingly, the electro-mechanical brake controller 120 may receive a signal indicating the occurrence of the vehicle ignition OFF from the controller 110. In response to receiving the signal indicating the occurrence of the vehicle ignition OFF, the electro-mechanical brake controller 120 may identify and store the parking mechanism state of the electro-mechanical brake 1200 before the brake system 1 is deactivated.

The electro-mechanical brake controller 120 may be activated based on the wake-up of the brake system 1 according to the vehicle ignition ON (605).

The electro-mechanical brake controller 120 may identify whether the parking mechanism state of the electro-mechanical brake 1200 stored in the memory 123, that is, whether the parking brake is engaged or disengaged (607).

The activated electro-mechanical brake controller 120 may identify whether the parking mechanism state of the electro-mechanical brake 1200 stored in the memory 123 is engaged or released during the initialization state of the brake system 1.

The electro-mechanical brake controller 120 may perform operation 609 when the mechanism state of the electro-mechanical brake 1200 stored in the memory 123 is engaged, and may perform operation 615 when the mechanism state is disengaged.

The electro-mechanical brake controller 120 may perform a physical state check of the parking brake mechanism of the electro-mechanical brake 1200 (609).

The electro-mechanical brake controller 120 may drive the motor 1200 to rotate the first drive pulley 1215 in a predetermined disengagement direction.

The electro-mechanical brake controller 120 may identify the state of the parking brake of the electro-mechanical brake 1200 based on the result of the physical state check of the parking brake mechanism (611).

If the first drive pulley 1215 rotates when the motor 1200 is driven to rotate the first drive pulley 1215 in a predetermined disengagement direction, the parking brake may be identified as being in the disengaged state.

The electro-mechanical brake controller 120 may identify whether the parking brake is engaged based on a signal output from a position sensor (not shown) of the motor 1211 in response to driving control of the motor 1211. For example, position information of the motor 1211 corresponding to the engagement of the parking brake may be previously stored, and the electro-mechanical brake controller 120 may identify whether the parking brake is engaged based on a comparison between the position information of the motor 1211 corresponding to the parking brake engagement previously stored and the position information acquired based on a signal output from the position sensor.

The electro-mechanical brake controller 120 may transmit information corresponding to the parking brake state identification result of the electro-mechanical brake 1200 to the controller 110 (613).

The controller 110 may receive the information corresponding to the state identification result of the electro-mechanical brake 1200 and transmit it to the vehicle controller. The vehicle controller may receive the information corresponding to the state identification result of the electro-mechanical brake 1200 and output it to the output device.

After operation 613, operation 601 may be performed again.

The electro-mechanical brake controller 120 may identify the state of the parking brake of the electro-mechanical brake 1200 as a disengaged state (615).

The electro-mechanical brake controller 120 may transmit information indicating the disengaged state of the parking brake to the controller 110 (617).

The controller 110 may receive information indicating the disengaged state of the parking brake and transmit the information to the vehicle controller. The vehicle controller may receive the information indicating the disengaged state of the parking brake and output it to an output device.

After operation 617, operation 601 may be performed again.

The brake system and its control method according to the above-described embodiments maintain the reliability of the initial state check of the electromechanical parking brake and can reduce the time required for the initial state check based on the state of the brake system in the previous ignition operation cycle (also referred to as the power cycle).

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term 'non-transitory' simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

1. A brake system comprising:
an electro-mechanical brake including a motor and a ratchet unit and configured to brake a wheel of a vehicle based on driving the motor and to engage a parking brake through operating the ratchet unit;
a memory configured to store state information of the parking brake of the electro-mechanical brake; and
a processor configured to control the motor and the ratchet unit,
wherein the processor is configured to identify whether the parking brake of the electro-mechanical brake is in an engaged state or a disengaged state based on the state information stored in the memory, in response to the vehicle’s ignition on.

2. The brake system of claim 1, wherein the state information is state information of the parking brake stored immediately before the brake system is deactivated in response to the vehicle’s ignition off.

3. The brake system of claim 1, wherein the processor is configured to identify that the parking brake is in the disengaged state when the state information stored in the memory is in the disengaged state.

4. The brake system of claim 1, wherein the processor is configured to perform a physical state check to identify whether the parking brake is in the engaged state or the disengaged state when the state information stored in the memory is in the engaged state.

5. The brake system of claim 4, wherein the processor is configured to identify whether the parking brake is in the engaged state or the disengaged state based on the physical state check.

6. The brake system of claim 4, wherein the processor is configured to perform the physical state check based on driving control of the motor.

7. The brake system of claim 6, wherein the electro-mechanical brake further includes a drive pulley configured to rotate based on a driving force of the motor, and
wherein the processor is configured to identify that the parking brake is in the disengaged state when the drive pulley rotates in response to the driving control of the motor.

8. The brake system of claim 7, wherein the ratchet unit includes:
a solenoid driver configured to generate mechanical motion based on a control signal from the electro-mechanical brake controller, and
a pawl configured to be moved by driving of the solenoid driver and be seated in a groove of a sawtooth protrusion on the drive pulley.

9. The brake system of claim 8, wherein the solenoid driver includes:
a solenoid coil configured to generate a magnetic field based on an electrical signal from the electro-mechanical brake controller,
an armature configured to move by the magnetic field generated by the solenoid coil, and
a pin configured to push the pawl in accordance with movement of the armature.

10. The brake system of claim 1, wherein the processor is configured to update the state information stored in the memory to current state information of the parking brake in response to identification of the vehicle’s ignition off signal.

11. A control method of a brake system comprising an electro-mechanical brake including a motor and a ratchet unit and configured to brake a wheel of a vehicle based on driving the motor and to engage a parking brake through operating the ratchet unit, the control method comprising:
identifying pre-stored state information of the electro-mechanical brake in response to the vehicle’s ignition on; and
identifying whether the parking brake of the electro-mechanical brake is in an engaged state or a disengaged state based on the pre-stored state information.

12. The control method of claim 11, wherein the pre-stored state information is state information of the parking brake stored immediately before the brake system is deactivated in response to the vehicle’s ignition off.

13. The control method of claim 11, wherein the identifying of whether the parking brake of the electro-mechanical brake is in the engaged state or the disengaged state includes:
identifying that the parking brake is in the disengaged state when the pre-stored state information is in the disengaged state.

14. The control method of claim 11, wherein the identifying of whether the parking brake of the electro-mechanical brake is in the engaged state or the disengaged state includes:
performing a physical state check to identify whether the parking brake is in the engaged state or the disengaged state when the pre-stored state information is in the engaged state.

15. The control method of claim 14, wherein the identifying of whether the parking brake of the electro-mechanical brake is in the engaged state or the disengaged state is performed based on the physical state check of the parking brake.

16. The control method of claim 14, wherein the performing of the physical state check is based on driving control of the motor.

17. The control method of claim 16, wherein the identifying of whether the parking brake of the electro-mechanical brake is in the engaged state or the disengaged state includes:
identifying that the parking brake is in the disengaged state when a drive pulley of the electro-mechanical brake rotates in response to driving control of the motor.

18. The control method of claim 17, wherein the ratchet unit includes:
a solenoid driver configured to generate mechanical motion, and
a pawl configured to be moved by driving of the solenoid driver and be seated in a groove of a sawtooth protrusion on the drive pulley.

19. The control method of claim 18, wherein the solenoid driver includes:
a solenoid coil configured to generate a magnetic field based on a received electrical signal,
an armature configured to move by the magnetic field generated by the solenoid coil, and
a pin configured to push the pawl in accordance with movement of the armature.

20. The control method of claim 11, further comprising:
updating the pre-stored state information to current state information of the parking brake in response to occurrence of the vehicle’s ignition off signal.
